(19) United States
(12) Patent Application Publication
(10) Pub. No.: US 2015/0052693 A1
(43) Pub. Date: Feb. 26, 2015

(54) RAMP

(71) Applicant: TRUCK-ALIGN CO. LIMITED, London (GB)

(72) Inventor: Robert John Allen, London (GB)

(21) Appl. No.: 14/378,946

(22) PCT Filed: Feb. 12, 2013
(86) PCT No.: PCT/GB2013/050312

§ 371 Date: Aug. 14, 2014

(30) Foreign Application Priority Data
Feb. 15, 2012 (GB) 1202638.1

(51) Int. Cl. B65G 69/28

(52) U.S. Cl. CPC B65G 69/28
USPC 14/71.1

(57) ABSTRACT

An extendible ramp for entrance to or egress from vehicles, such as buses, includes sensors arranged to detect whether the ramp abuts an obstruction. The ramp assembly comprises a chassis, a ramp extendible from the chassis, a frame which carries the chassis and a sensor arranged to sense movement of the chassis relative to the frame. The chassis is mounted in the frame such that it moves relative to the frame in response to both abutment of the leading edge of the ramp against an obstacle and in response to vertical force applied to the top of the extended, or partially extended ramp. The chassis also moves relative to the frame in response to a force applied to the side of the extended or partially extended ramp.

### CROSS-REFERENCE TO RELATED APPLICATIONS

This application is a US 371 National Phase filing of International PCT Patent Application No. PCT/GB2013/050312, filed Feb. 12, 2013, which claims the benefit of GB priority application no. 1202638.1, filed Feb. 15, 2012 and is incorporated herein by reference.

### BACKGROUND

The exemplary embodiment provides an extendible ramp for entrance to or egress from vehicles, such as buses, includes sensors arranged to detect whether the ramp abuts an obstruction. The ramp assembly comprises a chassis, a ramp extendible from the chassis, a frame which carries the chassis and a sensor arranged to sense movement of the chassis relative to the frame. The chassis is mounted in the frame such that it moves relative to the frame in response to both abutment of the leading edge of the ramp against an obstacle and in response to vertical force applied to the top of the extended, or partially extended ramp. The chassis also moves relative to the frame in response to a force applied to the side of the extended or partially extended ramp.

### BRIEF DESCRIPTION OF SEVERAL VIEWS OF THE DRAWINGS

Embodiments of the present invention will be described by way of non-limiting example with reference to the accompanying figures, in which:

FIG. 1 shows a perspective view of a ramp assembly in the extended configuration;

FIG. 2 shows a perspective view of the ramp assembly of FIG. 1 in the extended configuration, with the frame not shown;

FIG. 3 shows a perspective view from underneath of the ramp assembly of FIGS. 1 and 2 but with the frame and part of the chassis not shown;

FIG. 4 shows a plan view of the ramp in

FIGS. 5a and 5b show schematic side views of parts of the ramp of FIGS. 1 to 4.

FIGS. 6a and 6b show schematic plan views of parts of the ramp of FIGS. 1 to 5.

### DETAILED DESCRIPTION

The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The present invention relates to a ramp and in particular an extendible ramp including sensors arranged to detect whether the ramp abuts an obstruction. Such ramps are typically provided for entrance to or egress from vehicles, normally public service vehicles, such as buses, although the ramp of the invention could also be used for other applications such as for entrance to or egress from buildings.

Ramps including sensors arranged to detect whether the ramp abuts an obstruction are known for example from WO00/20252. Two techniques are taught by this disclosure which relates to a two-stage ramp in which a first ramp carries a second ramp.

In WO00/20252, the first ramp is driven by a motor and, in order to detect whether the first ramp abuts an obstacle, a control unit monitors the current drawn by the motor. If movement of the ramp is inhibited, for example by the leading edge of the ramp contacting a person, the motor draws a higher current. The control unit senses this and either switches off or reverses the motor.

The second ramp is driven by a pneumatic ram, which is mounted resiliently on the first ramp. The ram is urged away from a microswitch by a resilient bias, thus if the leading edge of the second ramp meets an obstruction, the bias is overcome and the microswitch is actuated. The control unit may then cause the ram to stop or retract.

Some single-stage ramps have been provided with pressure pads on their top surface in order to detect a person stepping onto the moving ramp and bring it to a halt.

Against this background there is provided an extendible ramp assembly comprising a chassis, a ramp extendible from the chassis, a frame which carries the chassis and a sensor arranged to sense movement of the chassis relative to the frame.

Compared to the “over-current” system, this invention presents an improvement in terms of reliability. The over-current system is sensitive not just to obstacles, but to anything else that increases the current required to extend the ramp. For example, dirt and detritus in the mechanism, seized bearings, badly maintained or damaged parts, or even cold weather can increase the current required to extend the ramp such that the control unit senses a higher current and switches off or reverses the motor even if no obstacle has been struck.

Compared to a two-stage ramp of the type described above, in which detection means for the first and second ramps are provided separately, the present invention also provides an advantage in terms of simplicity; whichever ramp abuts an obstacle, the chassis will move relative to the frame, so only one sensing device would be required to detect the obstacle—this reduction in the number of sensing devices required brings with it an improvement in terms of reliability as there are fewer parts that may fail.

Preferably the chassis is mounted in the frame such that it moves relative to the frame in response to both abutment of the leading edge of the ramp against an obstacle and in response to vertical force applied to the top of the extended, or partially extended ramp.

Such a ramp which would not require the additional component of a pressure pad in order to detect vertical motion and therefore has advantages in terms of simplicity and reliability.

More preferably still, the chassis is mounted in the frame such that it moves relative to the frame in response to a force applied to the side of the extended or partially extended ramp.

This additional movement allows the sensor to detect whether either side of the ramp abuts an obstacle, delivering the possibility to stop the ramp when an obstacle is met that would be undetected in the prior art.

Preferably the chassis is pivotally attached to the frame. More preferably the chassis is pivotally suspended from the frame. Even more preferably at least one side of the chassis is pivotally suspended from the frame by at least two pivoting links which are inclined relative to one another.

Alternatively the chassis is slidably attached to the frame. Preferably the slidable attachment is by means of fingers extending from the sides of the chassis into inclined slots in the frame, or by means of fingers extending from the sides of the frame into inclined slots in the chassis.

Preferably the extendible ramp assembly comprises a plurality of sensors. A greater number of sensors allow different types of movement to be detected.

Preferably the chassis has two sides, the ramp extends from the front of the chassis and the back is opposite the front and at least one sensor is positioned at the back of the chassis. A sensor at the back of the chassis will detect when the leading edge of the ramp abuts an obstacle, because when the leading edge abuts the obstacle, the chassis will be pushed backwards relative to the frame. Moreover, arrangement of relationship between the chassis and the frame as discussed above, can allow for backwards movement of the chassis in relation to the frame in response to a vertical force, thus a single sensor can detect both types of obstacles.

Preferably at least two sensors are positioned at the back of the chassis, one closer to a first side and the other closer to a second side. Provision of two sensors, at the back of the chassis, one to the left and one to the right, assists in detection of sideways force. This is because force on the side of the extended or partially extended ramp can cause the chassis it to twist relative to the frame, i.e. force on the front left of the ramp would cause the back right of the chassis to move backwards. Accordingly with sensors towards the left and right hand side at the back of the chassis, backward motion of part of the chassis will be detected by one or other of the sensors.

Preferably, in addition to the at least one sensor at the back of the chassis, at least one further sensor is positioned at one side of the chassis. Such a sensor allows detection of twisting motion even if the sensor at the back of the chassis is positioned in the middle. Indeed two sensors, one at one side, positioned towards the back, and the other at the back, positioned towards the same side, should be capable of detecting backward motion of the chassis relative to the frame as well as vertical force and sideways motion from either side.

Preferably however, at least two further sensors are provided, one positioned at each side of the chassis. By this means, the back sensor can be positioned in the middle and will react only to backwards or vertical forces and each side sensor will react to sideways force on a respective side of the ramp. This will allow information about what type of force is exerted on the ramp to be collected and could be used to display such information to the driver so that he can take appropriate action, or saved in memory to be subsequently accessed by ramp manufacturers/repairers.

Preferably the further sensor or sensors which are provided on the, or each side of the, chassis are positioned towards the back of or each side. While twisting of the chassis in relation to the frame could be detected by sensors at the front, or even, if the chassis is mounted to allow sideways sliding, in the middle, positioning towards the back is advantageous in terms of keeping the sensors away from the exterior and free from dirt etc.

In a second aspect of the invention, there is provided a vehicle comprising a frame which carries a chassis, the chassis housing an extendible ramp and sensors arranged to sense movement of the chassis relative to the frame.

In this case, the frame may be formed as part of the vehicle rather than as a separate component. However, in most cases, it is usual for the ramp assembly to be manufactured by a contractor and installed in position in the floor of a vehicle, therefore, normally even in a vehicle according to the second aspect of the invention, the frame will be formed as part of a ramp unit which is installed in the vehicle.

It should be emphasized that the chassis need not be a substantial item, such as the cassette described in WO00/20252 which surrounds the entire ramp assembly. Instead, the chassis could be provided for example by a pair of runners along which the ramp may run, so as to extend outwardly. The novel and important feature of the invention is that the chassis, whatever its form, is mounted such that it is movable relative to the frame, so movement of the chassis rather than the ramp (or ramps) is detected.

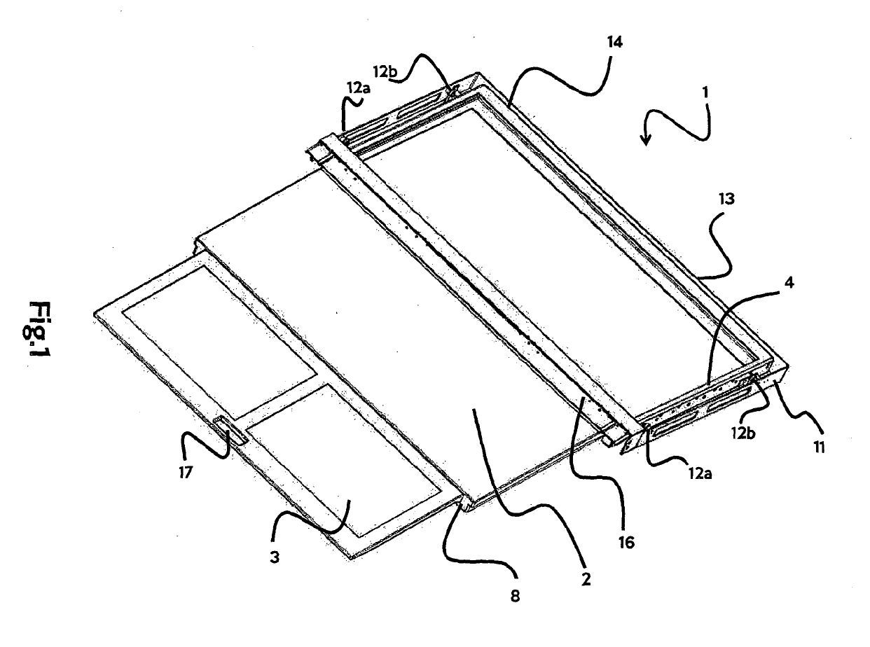

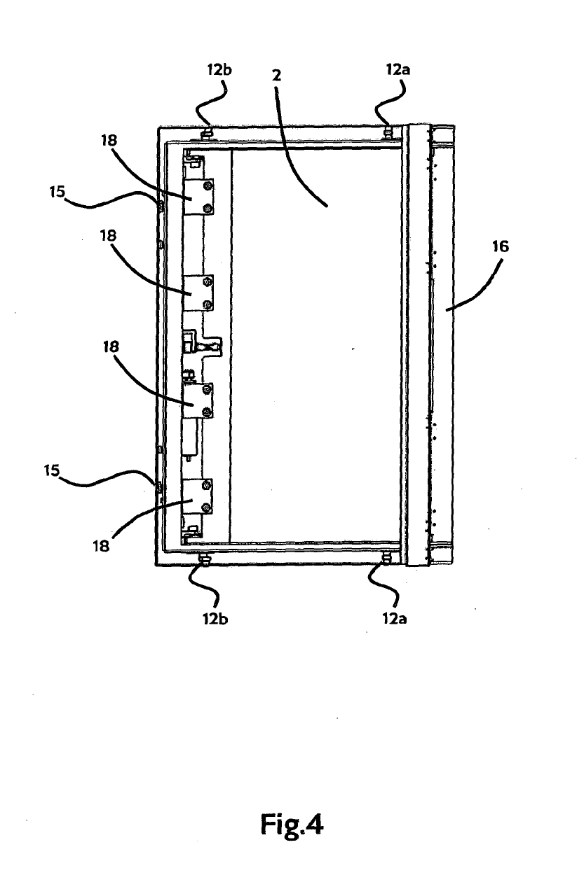

With reference to FIGS. 1 to 4 it can be seen that the ramp assembly 1 of this embodiment is a two-stage ramp, having a first ramp 2 extendible from the chassis and a second ramp 3 which is carried by the first ramp 1 and extends out of the first ramp 2 and from the chassis 4 from the position shown in FIG. 4 (in which the second ramp cannot be seen as it is within the first ramp) to the position shown in FIGS. 1 to 3.

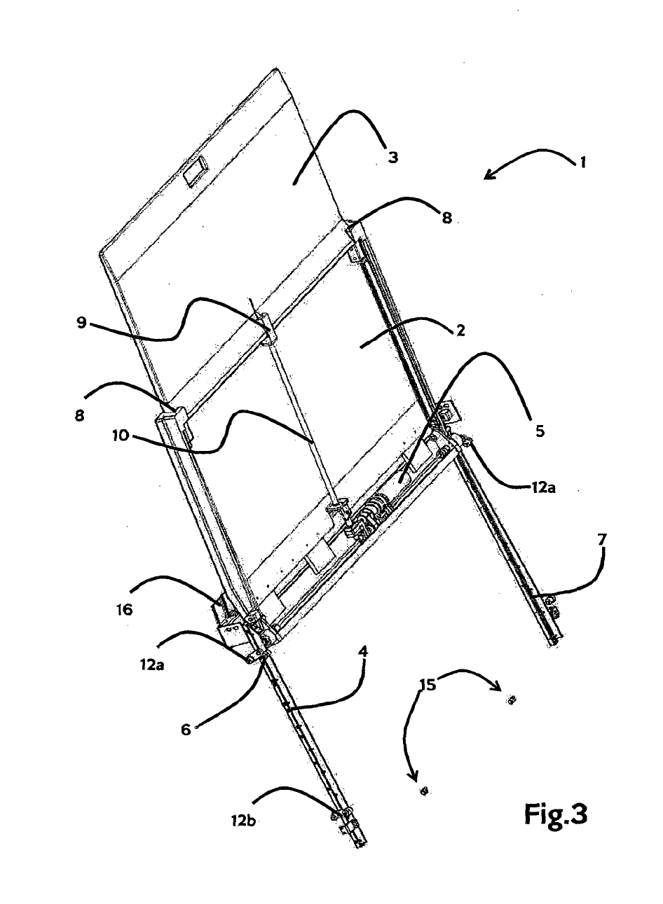

As shown in FIG. 3, in this embodiment, the ramps 2,3 are driven out of the chassis 4 simultaneously by means of a drive source in the form of a motor 5 carried by the first ramp 2 (from the stowed position of FIG. 4). The motor 5 is arranged to drive a pair of pinions 6 which are located at the back of the first ramp 2 and engage with the teeth on a pair of racks 7 which form part of the chassis 4. Rotation of the pinions 6 causes the first ramp 2 (which carries the second ramp 3) to extend from or retract into the chassis 4.

In addition to extending and retracting by virtue of being carried by the first ramp 2, the second ramp 3 is also actively driven out of the first ramp 2 by the same motor 5. The second ramp 3 slides along a track 4 defined by pair of lateral grooves or “slide guides” 8 at the front of the first ramp 2. The second ramp 3 is provided with a feed nut 9 which is centrally located at the bottom of the second ramp 3 towards the rear. The feed nut 9 engages a feed screw 10 which is also coupled to the spindle of the motor 5. Accordingly, when the motor 5 is actuated, the pinions 6 and the feed screw 10 are caused to rotate simultaneously, so that the first ramp 2 extends from the chassis 4 and the second ramp 3 simultaneously extends from the first ramp 2.

The connection between the spindle of the motor 5 and the pinions 6 and feed screw 10 may be by means of drive shafts and bevel gears which will be well understood by those skilled in the art and are described in greater detail in WO2000/20252.

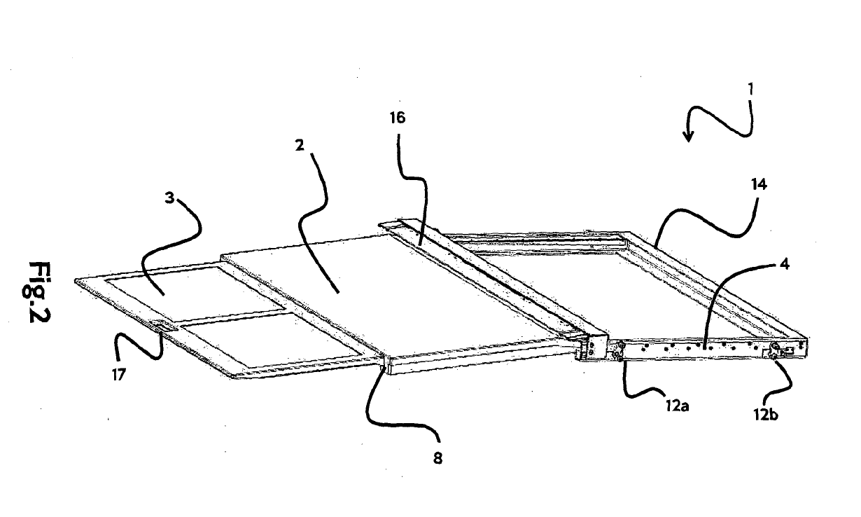

The ramp assembly includes a frame 11 (not shown in FIG. 2 or 3) which carries the chassis 4 and which in use will frequently be attached to the sub-frame of a vehicle, often a bus, such that the upper surface of a cover (not shown) provides part of the floor of the bus at an entrance. It will be appreciated that this frame 11 could feasibly be formed as an integral part of a vehicle, although that is not a typical construction.

A feature of the invention is that the position of the chassis 4 is not fixed in relation to the frame 11. In this embodiment, movement of the chassis 4 in relation to the frame 11 is provided by means of two pairs of inclined links 12a and 12b which are pivotally connected to both the chassis 4 and the frame 11.

The links 12a and 12b are provided at the sides of the frame assembly 1 and one pair of links 12a and 12b connects one side of the frame 11 to the corresponding side of the chassis 4, while the other pair of links 12a and 12b connects the other side of the frame 11 to the other side of the chassis 4. Each link 12a or 12b is provided with two pivot points one above the other and the upper pivot point of each link is connected to the frame 11, while the lower pivot point is attached to the chassis 4. Accordingly, the chassis 4 is pivotally suspended from the frame 11 by the links 12a and 12b.

The inclination of each link 12a relative to the other link 12b in the pair is such that a trapezoid can be defined by the connections between the four pivot points. In the rest position the frame 11 and chassis 4 are normally horizontal and conveniently the upper pivot points are attached at the same height in relation to the frame 11 a certain distance apart. For example, in a ramp assembly that is about 500 mm deep (when closed), the pivot points could be about 400 mm apart, but of course this is fairly arbitrary and can be easily modified by the man skilled in the art. The lower pivot points which are attached to the chassis 4 are again attached at the same height (although this is not essential), and are separated by a larger distance than the upper pivot points. As an example, the distance between the pivot point in each link 12a or 12b could be 30 mm and the bottom pivot points could be about 420 mm apart. Thus a trapezoid can be defined with two parallel sides of 400 mm and 420 mm and two inclined sides each of 30 mm.

In addition to side plates to which the links are pivotally attached, the frame 11 includes a back plate 13. The chassis 4 also has a back plate 14 (not shown in FIG. 3) and the back plate 13 of the frame 11 is spaced from the back plate 14 of the chassis 4. In the space between the back plates 13,14 a pair of sensors 15 are disposed.

The sensors 15 in this embodiment are in the form of micro-switches and are attached to the frame 11, one towards the left hand side of the back plate 13, the other towards the right hand side. As an example, in a ramp assembly 1 that is 1000 mm wide, the sensors 15 may be situated about 500 mm apart, with one about 250 mm from the left hand side and the other about 250 mm from the right hand side. The micro-switches are provided such that their actuator buttons face the back plate 14 of the chassis 4.

Accordingly, movement of the back plate 14 of the chassis 4 towards the back plate 13 of the frame 11 actuates the micro-switch 15. The micro-switches 15 are connected to a control unit (not shown) which can thereby sense movement of the chassis 4 in relation to the frame 11 and switch off motor 5 to halt extension/retraction. The control unit may have additional functions, such as storing information on which sensor 15 has been activated and when in a memory, or displaying such information to an operator.

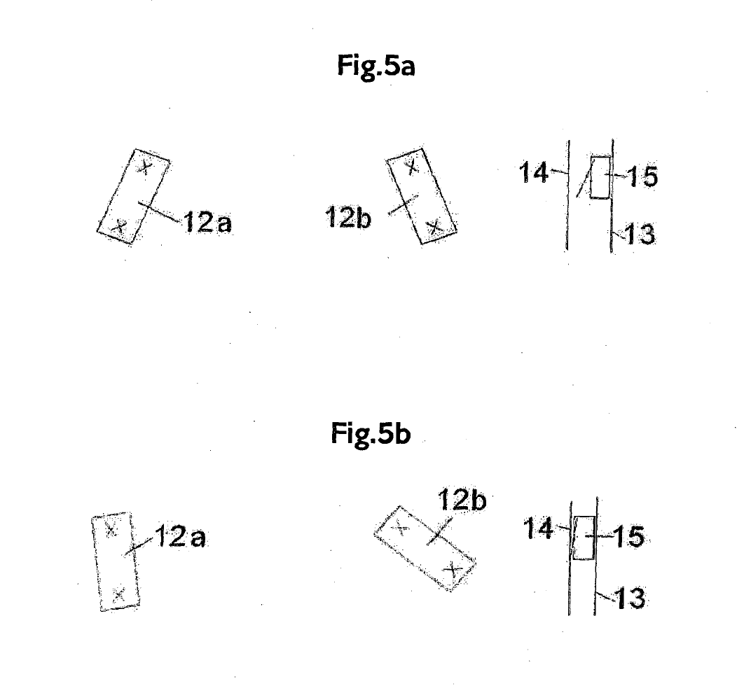

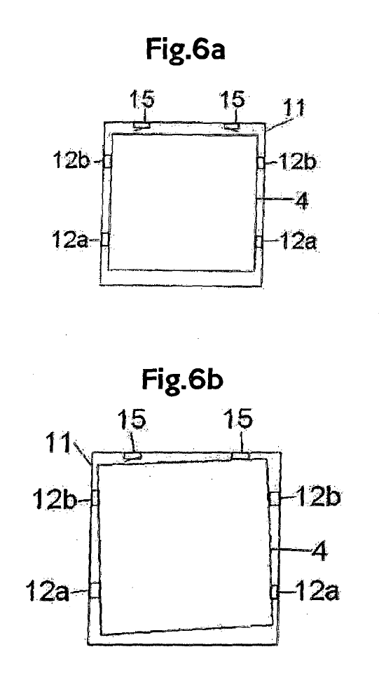

In order to elaborate on how the ramp assembly 1 according to this embodiment can sense abutment of different obstacles reference is made to the schematic drawings of FIGS. 5a and 5b and FIGS. 6a and 6b.

FIG. 5a shows schematically a pair of links 12a and 12b when the ramp assembly 1 is in the rest position and also represents the position in which the links 12a, and 12b will remain when the ramps 2,3 extend, provided they do not hit any obstacles. It can be seen that the weight of the chassis is evenly distributed between the links 12a,12b, so they are inclined in opposite directions. In FIG. 5a, the front (left hand) link 12a is located closest to the front of the assembly 1 and the rear link 12b on the right hand side is closest to the back of the assembly 1. Both the pair of links 12a, 12b on the right hand side and the pair on the left hand side will have the same configuration at rest. The back plate 14 of the chassis 4 is also shown and it can be seen that it is spaced away from the back plate 13 of the frame 11, with a micro-switch 15 in between. FIG. 5b shows the position of the links when the ramps 2,3 extend forwards and hit an obstacle at the front. In this case, the abutment with the obstacle means that the extending motion of the ramps 2,3 is not translated into forward motion of the ramps, but instead into backwards motion of the chassis 4. Because the chassis is mounted movably, suspended from front links 12a and rear links 12b, continued motion of the pinion along the rack (and feed screw in the feed nut) causes the chassis itself to move backwards. Thus the links 12a and 12b rotate about the upper pivot point (where they are attached to the frame 11) so that the back plate 14 of the chassis 4 moves towards the back plate of the actuates the micro-switch 15. The control unit will then stop power to the motor and alert the operator.

It will be appreciated that if the obstacle abuts the front of the ramps 2,3 in the middle, the links 12a,12b at both sides will move in the same way. On the other hand, if an obstacle is abutted towards one side or the other of the front of the ramps 2,3, the links 12a, 12b on the side which is abutted will move in the manner described and shown, but links 12a, 12b on the other side may remain in the rest position.

If an obstacle abuts the top of one of the ramps 2,3 during extension, a similar motion will follow. Because of the offset nature of the pivoting links 12a,12b, downward pressure on the front of the ramp will result in a larger force downwards at the front of the chassis 4. This in turn will urge the forward links 12a to rotate to the position shown in FIG. 5b. The micro-switch 15 will therefore be actuated and extension of the ramp will be stopped. It should be noted that the motion will be the same if the ramps 2,3 are retracting and the retraction can also be stopped but the control unit. Thus if a person moves onto the ramp as it is being retracted it will stop and remain in place under the person.

FIG. 6a shows a schematic plan view of the chassis 4, frame 11, links 12a and 12b and sensors 15. The ramps are omitted for simplicity. In FIG. 6a the ramp is in its rest position, the links 12a, 12b are in the same position as in FIG. 5a and the chassis 4 is square with the frame 11 (i.e. the back plate 14 of the chassis is parallel to the back plate 13 of the frame). FIG. 6b shows the position when one of the ramps 2,3 (either partially or fully extended) abuts an obstacle from the side. In FIG. 6b the ramp has been hit from the left hand side and this causes the chassis to rotate (anticlockwise) in relation to the frame 11. The links 12a, 12b on the right hand side will have moved to the position shown in FIG. 5b, while the links 12a, 12b on the left hand side remain in the same position as at rest. Accordingly, the back plate 14 of the chassis 4 is no longer parallel to the back plate 13 of the frame 11 and the side opposite that which the obstacle abuts moves backwards (in the drawing, the left hand side of one of the ramps 2,3 hits an obstacle, so the right hand side of the back plate 14 has moved backwards).

The backwards motion causes one of the micro-switches 15 (opposite to the side which is hit) to be actuated. As previously this allows the control unit to sense that an obstacle has been encountered and stop the ramp 2,3 from extending (or retracting) any further. Again, the control unit may send a signal to the operator to draw attention to the obstacle and in view of the fact that the sensor 15 is actuated according to which side of the ramp 2,3 abuts an obstacle, the operator can be provided with a greater amount of information. This may allow the operator to slowly move the vehicle away from the obstacle, if it is safe to do so.

In common with prior art ramps, the ramp assembly 1 of the present invention includes features such as a flap 16 at the front of the chassis which closes the slot through which the ramps 2,3 extend. The second ramp 3 also includes a handle 17 at the front in order to allow the ramps to be manually stowed or extended. (Alternatively the end of the feed screw could be provided with a dog which could be engaged with a tool to allow manual operation. This is useful in emergencies for example if motor 10 fails.

Hinges 18 shown most clearly in FIG. 4 are provided at the back of the first ramp 3 and are formed of a resilient material such as polyurethane, so that they can bend and allow the front of the second ramp 3 to be lowered to the ground.

The top surfaces of the ramps 2,3 are generally provided with a ribbed surface or other textured surface which may be resilient to improve traction of people and vehicles such as wheelchairs ascending or descending the ramps 2,3.

In some embodiments further sensors are provided to sense the condition of one or more of the handbrake, the speed of the vehicle and the vehicle doors. The control unit can monitor the sensor or sensors and for example can prevent actuation of the ramp until the handbrake is on and the vehicle speed is less than a predetermined speed for example 5 kph.

In an embodiment of the invention the control unit prevents deployment of the ramp unless the vehicle is moving at less than 5 kph, the handbrake is on and the doors are closed.

To deploy the ramp a deployment switch is pressed and held until the ramp is fully deployed. Release of the deployment switch causes the control unit to retract the ramp. When the ramp is fully extended the deployment switch can be released and the doors opened. The control unit may actuate a ramp extended warning indicator. A warning signal for example visual and/or audible may be given during deployment.

To retract the ramp the control unit monitors the handbrake and the doors. Retraction cannot be performed unless the doors are shut and the handbrake is on. Redeployment can be prevented until a time delay for example 10 seconds has expired.

A number of ways of reducing the likelihood of the vehicle being driven while the ramp is extended can be provided. They can include one or more of a warning signal for example visual and/or audible, the control unit could actuate the vehicle's brakes such as the handbrake could prevent engagement of the vehicle drive and/or could prevent an engine speed from being increased above a particular level.

In some embodiments of the invention the vehicle must be stationary before the ramp can be deployed.

Various further modifications and alterations to the ramp assembly may be considered by those skilled in the art. For example although the invention has been described in relation to a two-stage ramp, it could also be applied to a one-stage ramp and while the particular embodiment uses a single motor as the drive source, a plurality of motors could provide a single drive source if connected to a common spindle for simultaneously extending both ramps. Alternatively the two ramps could be driven by separate drive sources as is common in the art and need not be driven by motors, but could instead be pneumatically or hydraulically operated, for example.

Likewise, while four pivoting links have been used in the invention which are pivotally connected both to the frame and the chassis, there need not necessarily be four such links and they may be fixed in relation to one of the chassis and the frame and only pivot in relation to the other. Likewise entirely different means of connection could be used to achieve the same effect, such as a sliding arrangement of fingers in slots. Similarly, while the embodiment is described with two sensors in the form of micro-switches, alternative types of sensors could be provided and, as discussed in the statements of invention, different numbers of sensors or positions of sensors can be provided. While it is preferable for the sensors to be attached to the frame 11 and actuated by the chassis 4, this arrangement could be transposed, and they could be attached instead to the chassis.

Accordingly, the scope of the invention should not be limited to the features of the embodiment as described, in combination, but should be determined by reference to the appended claims, having due regard to equivalents.

1. An extendible ramp assembly comprising a chassis, a ramp extendible from the chassis, a frame which carries the chassis and a sensor arranged to sense movement of the chassis relative to the frame.

2. An extendible ramp assembly according to claim 1 wherein the chassis is mounted in the frame such that it moves relative to the frame in response to both abutment of the leading edge of the ramp against an obstacle and in response to vertical force applied to the top of the extended, or partially extended ramp.

3. An extendible ramp assembly according to claim 1 or 2 wherein the chassis is mounted in the frame such that it moves relative to the frame in response to a force applied to the side of the extended or partially extended ramp.

4. An extendible ramp assembly according to any of claims 1 to 3 wherein the chassis is pivotally attached to the frame.

5. An extendible ramp assembly according to claim 4 wherein the chassis is pivotally suspended from the frame.

6. An extendible ramp assembly according to claim 5 wherein the chassis comprises at least one side and said at least one side of the chassis is pivotally suspended from the frame by at least two pivoting links which are inclined relative to one another.

7. An extendible ramp assembly according to claim 5 or 6 wherein the chassis has two sides and both sides are pivotally suspended from the frame by at least one pivoting link, the pivoting links being inclined relative to one another.

8. An extendible ramp assembly according to any of the preceding claims wherein the chassis is slidably attached to the frame.

9. An extendible ramp assembly according to claim 8 wherein the chassis is slidably attached to the frame by means of fingers extending from at least one side of the chassis into inclined slots in the frame.

10. An extendible ramp assembly according to claim 7 wherein the chassis is slidably attached to the frame by means of fingers extending from at least one side of the frame into inclined slots in the chassis.

11. An extendible ramp assembly according to any of claims 8 to 10 wherein the chassis has two sides and both sides are slidably attached to the frame.

12. An extendible ramp assembly according to any of the preceding claims wherein the ramp extendible from the chassis comprises a first ramp extendible from the chassis and a second ramp carried by the first ramp and extendible from the first ramp and from the chassis.

13. An extendible ramp assembly according to any of the preceding claims wherein the sensor is a plurality of sensors.

14. An extendible ramp assembly according to any of the preceding claims wherein the chassis has two sides, the ramp extends from the front of the chassis and the back is opposite the front and wherein at least one sensor is positioned at the back of the chassis.

15. An extendible ramp assembly according to claim 14 wherein at least two sensors are positioned at the back of the chassis, one closer to a first side and the other closer to a second side.

16. An extendible ramp assembly according to claim 14 wherein at least one further sensor is positioned at one side of the chassis.

17. An extendible ramp assembly according to claim 14 wherein at least two further sensors are provided, one positioned at each side of the chassis.

18. An extendible ramp assembly according to claim 16 or 17 wherein the further sensor or sensors which are provided on the or each side of the chassis are positioned towards the back of the or each side.

19. A vehicle comprising a frame which carries a chassis, the chassis housing an extendible ramp and a sensor arranged to sense movement of the chassis relative to the frame.

20. A vehicle according to claim 19 comprising an extendible ramp according to any of claims 2 to 18.

21. A ramp assembly substantially as described herein with reference to the accompanying drawings.

22. A vehicle substantially as described herein with reference to the accompanying drawings.
